(19) United States
(12) Patent Application Publication
(10) Pub. No.: US 2008/0167950 A1
(43) Pub. Date: Jul. 10, 2008

(54) Virtual advertising network agency

(76) Inventors: Yaacov Barki, Tel Aviv (IL); Netta Ness Cohen, Moshav Tsur Moshe (IL)

Correspondence Address: ROBERT G. LEV, 4766 MICHIGAN BLVD., YOUNGSTOWN, OH, 44505, US

(21) Appl. No.: 12/005,819

(22) Filed: Dec. 28, 2007

Related U.S. Application Data
(60) Provisional application No. 60/878,744, filed on Jan. 5, 2007.

(51) Int. Cl. G06Q 30/00

(52) U.S. Cl. 705/10; 705/14

(57) ABSTRACT

A virtual advertising agency comprising an internet based forum supported by a website that enables internet enabled members of the public to upload content relating to at least a first branded consumer product to the website via web browsers; the virtual agency for mediating between brand owner of said first consumer product and said members of the public, to allow brand owner to provide incentives or rewards to members of public in exchange for content that can serve in advertising campaigns for the consumer products.

### FIELD OF THE INVENTION

The present invention relates to mediating between brand owning advertisers and web surfers to develop advertising campaigns and particularly to identifying and cultivating a group of web users as content providers. It also relates to a method and system for creating a virtual advertising agency made up of internet enabled members of the public.

### BACKGROUND

An advertising agency, or ad agency, is a service business dedicated to creating, planning and handling advertising (and sometimes other forms of promotion) for its clients. An ad agency is independent from the client and provides an outside point of view to the effort of selling the client's products or services. An agency can also handle overall marketing and branding strategies and sales promotions for its clients. Not all advertising and advertising campaigns are created by agencies. Companies that create and plan their own advertising are said to do their work in house.

Ad agencies come in all sizes. They include everything from one or two-person shops, small to medium sized agencies, large independents, and multi-national, multi-agency conglomerates such as Omnicom Group, WPP Group, Interpublic Group of Companies and Havas.

The major department of conventional ad agencies is the creative department. The creative department—the people who create the actual ads—form the core of an advertising agency. Modern advertising agencies usually form their copywriters and art directors into creative teams. Creative teams may be permanent partnerships or formed on a project-by-project basis. The art director and copywriter typically report to a creative director, that is usually a creative employee with several years of experience.

It will be noted that although copywriters include the word “write” in their job title, and art directors include the word “art”, the former does not necessarily write the words and the latter does not necessarily draw the pictures. They both generate creative ideas to represent the proposition, i.e. the advertisement or campaign's key message.

The inventors of the present invention contend that many firms in this hundred year old business are stuck in business model that has outlived its usefulness.

There are various forms of creating content on the web (henceforth User Generated Content) and sharing it with each others. This form of communication is generally considered to be Content from anywhere that can be viewed by anyone. What stands out is that it is unedited material. Examples of user generated content can be found in the shape of picture videos on youtube.com, heavy.com, myspace.com and currenttv.com. Other examples include blogs, and similar websites.

Recently, various advertisers have tried to stimulate their perspective users/consumers in a joint effort to create their next commercial. However, these sporadic ventures lack a user profiling mechanism and currently do not fall under the umbrella of an advertising agency.

Thus, despite the developments described above, there is still a need for improved advertising agency models that overcome the disadvantages of the prior art. The present invention addresses this need.

### SUMMARY OF THE INVENTION

It is an aim of the invention to provide alternative advertising forums that enable consumers to contribute creative content to advertising campaigns and to be rewarded for so doing.

In a first embodiment, the present invention is directed to providing a virtual advertising agency comprising an internet based forum supported by a website that enables internet enabled members of the public to upload content relating to at least a first branded consumer product to the website via web browsers; the virtual agency for mediating between brand owner of said first consumer product and said members of the public, to allow brand owner to provide incentives or rewards to members of public in exchange for content that can serve in advertising campaigns for the consumer products.

Optionally, the virtual advertising agency is a mediated forum that is mediated by an advertising executive with previous experience in traditional advertising.

Optionally, the virtual advertising agency of claim 2 further comprises other functionaries, such as copywriters and creative directors, for example.

In a second aspect, the present invention is directed to providing a method of providing a pool of creators comprising the steps of: (i) registering users; (ii) categorizing the users by filtering and screening techniques; (iii) Profiling the users, and (iv) approving the users as advertising agents.

Typically, the step of characterizing includes at least one categorizing category selected from the list of: Gender, Age, Income Bracket, Interests, Hobbies, Marital Status, Education, Religion, Beliefs, Superstitions and Politics.

Typically, the step of selection of an appropriate pool of creators includes specifying appropriate candidates by category values appropriate to target audience of a product to be advertised.

Optionally, the step of profiling consists of at least one subset selected from the list of: Creativity, Availability, Experience and Previous Performance.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice.

In the accompanying drawings:

FIG. 1 is a flowchart illustrating the process by which a consumer becomes an advertising agent;

FIG. 2 is a flowchart illustrating possible selection means for filtering an appropriate pool of candidates, and

FIG. 3 is a flowchart illustrating profiling characteristics for profiling individual potential creators.

### DESCRIPTION OF THE PREFERRED EMBODIMENTS

The present invention relates to a new model of advertising agency. Known hereinafter as “the people's agency”, this creates additional functionality by positioning itself as a citizen's agency and opens up a dialogue with the consumer. Being part of an agency, users get involved in the brand, have a sense of co-ownership and community, and their creativity is empowered. A wave of user's creativity in the shape of videos, music and texts will be released.

The evolution of User Generated Content to a viable advertising medium or User Generated Content Ads presents a new set of opportunities that serves four entities; media owners, advertisers, agencies and consumers.

Unlike consumers as traditionally defined, that were fed material, consumers can now contribute something to the creative process that up until now was controlled by advertising agencies and advertisers alone. By engaging consumers in the brand promotion of goods, the consumers are directed to think of different ways to use a product and to relate to brands. This provides a sense of brand ownership to the consumer, building a closer relationship between the consumer and the brand.

Corporations will use the people's agency to create goods, services and experiences in close cooperation with experienced and creative consumers, tapping into a vast bank of intellectual capabilities. In exchange, the corporations give the contributors influence on what actually gets produced, manufactured, developed, designed, serviced, or processed. Possibly, providing financial incentives and other incentives.

Such incentives may include, inter alia:
Status: people love to be seen; love to show off their creative skills and thinking.
Bespoke lifestyle: something consumers have been personally involved in should guarantee goods, services and experiences that are tailored to their needs.
Money: getting a well deserved reward or even a profit cut for helping a company develop The Next Big Thing is irresistible.
Employment: in an almost ironic twist, CUSTOMER-MADE is turning out to be a great vehicle for finding employment, as it helps companies recruit their next in-house designer, guerrilla advertising agency or brilliant strategist.
Fun and involvement: there's pleasure and satisfaction to be derived from making and creating, especially if co-creating with brands one loves, likes or at least feels empathy for?

The People's Agency represents allows creation of messaging that resonates with the consumer who is actively involved in its creation. A new dialogue is thus created that provides users with a sense of ownership on the creation of User Generated Content ads, it asks them to respond and take action. It provides a new framework where advertisers and advertising agencies become a consumer of the creative content that users i.e. the traditional consumers are now feeding them with.

The present invention lends itself to several possible business models:

In one embodiment, the present invention relates to an independent site i.e. myspace.com that offers its users the possibility to launch their own ad agency and compete against each other by creating briefs that are inspired by real companies/brands. By using this method, the main thing the advertiser gains is ENGAGEMENT. EXPOSURE, GRP.

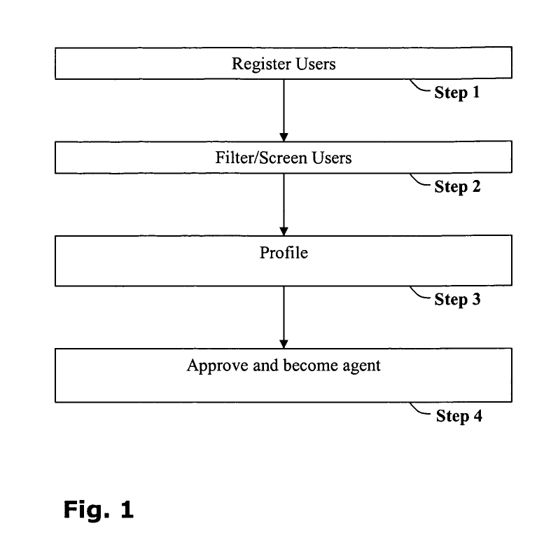

Referring to FIG. 1 a process showing how a consumer can become an advertising agent is shown. Essentially, a user is registered (step 1). The registered users are categorized by filtering and screening techniques (step 2) and then profiled (step 3). Once profiled, selected users are approved as advertising agents (step 4).

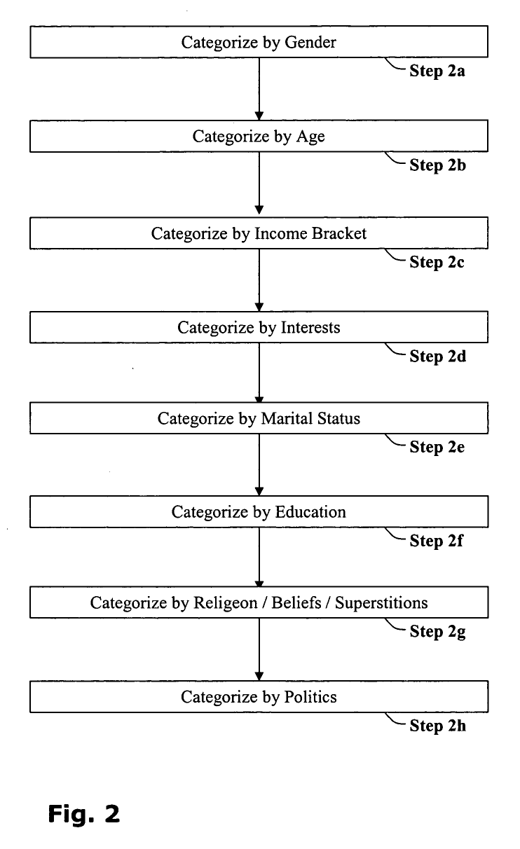

With reference now to FIG. 2, the step of characterizing may include any or all of the following steps: Categorizing by Gender: male/female—Step 2a; Categorizing by age: teenage/young adult/middle age/retired—Step 2b; Categorizing by Income Bracket: Percentiles—Step 2c; Categorizing by interests, hobbies, etc. such as: ornithology, philately, theatre, reading, cooking, knitting, model making, amateur dramatics, etc. —Step 2d; Categorizing by Marital Status: single/married/divorced/widowed—Step 2e; Categorizing by Education: basic/high school/graduate/technical/Ph.D—Step 2f; categorizing by Religion: Atheist/catholic/Protestant/Jewish,/Muslim/Hindu/Sikh/Zorastrian/Buddhist, etc. beliefs/superstitions Step 2g; Categorized by Politics—Step 2h, etc. etc. Such methods of categorizing participants is well established for target audiences for testing new products, advertising campaigns and the like. To the knowledge of the inventors of the virtual advertising agency as described herein, application of the categorizing in this manner to identify and define a pool of creators having an affinity to a target audience for a particular product is unique.

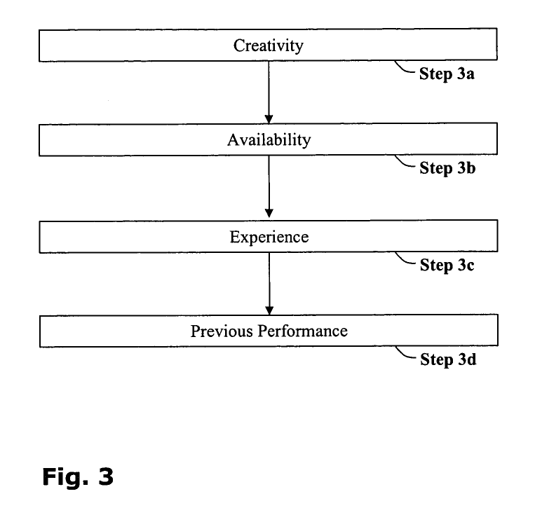

Referring to FIG. 3, the step of profiling 3 may consist of a number of substeps for classifying each individual with appropriate personal skills for the particular assignment, the profile will typically include an indication of creativity—Step 3a. The indication of creativity is more or less synonymous with raw talent, and will typically be assessed by performance in set tasks. Another important profiling characteristic for the success of a particular product, particularly where tight deadlines require being met, is Availability—Step 3b. Obviously, the most talented participants may not be available, particularly if committed to other projects. Although it is a major feature of the present invention that an almost unlimited pool of fresh talent is available, another useful profiling element is Experience—Step 3c, which is a valuable commodity as long as the creator is not jaded and cynical. A further valuable profiling technique is Previous Performance—Step 3d. It will be appreciated that not all of these profiling techniques will necessarily be used in all cases. Furthermore, the order in which profiling techniques are applied and the relative emphasis, or weighting, given to each profiling technique is capable of much variation and scenario specific optimization.

In a second embodiment the present invention provides an advertising agency that works exclusively as a user generated content agency with emphasis on the global aspect or broader spectrum. By pinpointing specific locations, advertising hubs are created; such as student groups, for example.

In a third embodiment, a virtual advertising agency based on the model of a traditional agency is created. In this model, collaboration between a selected leading figure in advertising is provided. The selected leading figure will monitor the flow of ideas coming in, and work around the good ones. At the same time other functionaries such as copywriters, creative directors, etc. are provided as and when necessary. These other functionaries overlook and direct work under their jurisdiction.

Each user is thus part of a virtual advertising agency. Associate agents are briefed, provided guiding and tools that enable the user to post his idea. Collaboration between users, i.e grouping, eventually results in a complete advertisement, commercial or advertising campaign. Each user who contributes creatively to the creation is acknowledged and rewarded in a manner analogous to a success fee. In all embodiments creators are identified, selected and/or profiled to suit specific scenarios.

Thus persons skilled in the art will appreciate that the present invention is not limited to what has been particularly shown and described hereinabove. Rather the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A virtual advertising agency comprising an internet based forum supported by a website that enables internet enabled members of the public to upload content relating to at least a first branded consumer product to the website via web browsers; the virtual agency for mediating between brand owner of said first consumer product and said members of the public, to allow brand owner to provide incentives or rewards to members of public in exchange for content that can serve in advertising campaigns for the consumer products.

2. The virtual advertising agency of claim 1 being a mediated forum mediated by an advertising executive with previous experience in traditional advertising.

3. The virtual advertising agency of claim 2 further comprising other functionaries.

4. The virtual advertising agency of claim 3, the other functionaries including at least one functionary selected from the list of copywriters and creative directors.

5. A method of providing a pool of creators comprising the steps of:
(i) Registering users;
(ii) Categorizing the users by filtering and screening techniques;
(iii) Profiling the users, and
(iv) Approving the users as advertising agents.

6. The method of claim 5 wherein the step of characterizing includes at least one categorizing category selected from the list of: Gender, Age, Income Bracket, Interests, Hobbies, Marital Status, Education, Religion, Beliefs, Superstitions and Politics.

7. The method of claim 5 wherein selection of an appropriate pool of creators includes specifying appropriate candidates by category values appropriate to target audience of a product to be advertised.

8. The method of claim 5 wherein the step of profiling consists of at least one subset selected from the list of: Creativity, Availability, Experience and Previous Performance.
